(19) United States
(12) Patent Application Publication
(10) Pub. No.: US 2006/0291151 A1
(43) Pub. Date: Dec. 28, 2006

(54) DISPLAY DEVICE WITH A SUPPORTER

(76) Inventor: Ching-Hui Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/278,151

(22) Filed: Mar. 31, 2006

(30) Foreign Application Priority Data
Jun. 27, 2005 (TW) 094121452

(51) Int. Cl. G06F 1/16

(52) U.S. Cl. 361/681; 248/917

(57) ABSTRACT

A display device includes a display screen and a supporter. The supporter includes a first hinge connected to the display device, a first connecting unit connected to the first hinge, a second hinge connected to the first connecting unit, a base connected to the second hinge, a third hinge connected to the base, and a second connecting unit connected to the third hinge, wherein the display screen and the first connecting unit are capable of rotating by utilizing the first hinge, the base and the first connecting unit are capable of rotating by utilizing the second hinge, and the base and the second connecting unit are capable of rotating by utilizing the third hinge.

### BACKGROUND OF THE INVENTION

1. Field of the Invention

The invention relates to a display screen, and more particularly, to a display screen with a novel supporter.

2. Description of the Prior Art

A display device is almost a necessary part of an electronic device. As technology has progressed, liquid crystal display (LCD) screens have gradually replaced the traditional cathode-ray tube (CRT) screen. LCDs have become the major products of the display market due to their characteristics of small volume and light weight.

Please refer to FIG. 1, which is a diagram of a typical LCD display 100 according to the prior art. As shown in FIG. 1, the LCD display 100 comprises an LCD screen 100 and a supporter 120 for supporting the LCD screen 110. Generally speaking, the supporter 120 comprises a hinge 130 for allowing the LCD screen 110 to rotate about the hinge 130. In other words, users can select a most appropriate view angel by adjusting the angle of the LCD screen 110 by utilizing the hinge 130.

However, the above-mentioned structure has some problems. For example, the supporter 120 may be a whole-forming structure or a fabricated structure. Therefore, if the entire LCD display 100 is to be moved to another place it may be necessary that the user need to first separate the LCD screen 110 from the supporter 120 then move the LCD screen 110 and the supporter 120 to the wanted place. In the case of a fabricated unit, the LCD screen 110 and the supporter 120 are a single piece that are moved together when being relocated. Given the above-mentioned fabricating steps the LCD display 100 will not be convenient to move. Furthermore, as shown in FIG. 1, because the supporter 120 is a fixed-type structure, the supporter 120 cannot utilize the space well. In other words, the LCD display 100 cannot sufficiently utilize the characteristics of small volume and light weight of the LCD screen 110.

TW patent No. 91208893 discloses a fixing device of the flat panel screen. The fixing device can be utilized as a supporter of the LCD screen. Furthermore, the fixing device can be folded up such that the whole display device can save more space.

In addition, TW patent No. 91215333 discloses a coupled structure. The coupled structure can be utilized in the LCD display field for hang the LCD display upside down, or utilized as a handle of the LCD display. However, in this patent, in order to hang the LCD display upside down, the coupled structure must have a large base such that the large base can support sufficient supporting force to the LCD display when the LCD display is hung upside down. Otherwise, the LCD display cannot be placed stably. However, because the base is larger, the entire LCD display cannot utilize the space efficiently. This causes inconvenience in packaging or placing the LCD display.

Furthermore, TW patent No. 91215335 discloses a multi-function supporter. The multi-function supporter is similar to the above-mentioned coupled structure. The multi-function supporter can be utilized in the LCD display such that the LCD display can be hung upside down, or utilized as a handle of the LCD display. Similarly, the multi-function supporter also requires a large base for providing sufficient supporting force. Therefore, the entire LCD display cannot efficiently utilize the space. This causes inconvenience in packaging or placing the LCD display.

### SUMMARY OF THE INVENTION

It is therefore one of primary objectives of the claimed invention to provide a display device with a special supporter, to solve the above-mentioned problem.

According to an exemplary embodiment of the claimed invention, a display device is disclosed. The display device comprises: a display screen; and a supporter. The supporter comprises: a first hinge connected to the display device; a first connecting unit connected to the first hinge; a second hinge connected to the first connecting unit; a base connected to the second hinge; a third hinge connected to the base; and a second connecting unit connected to the third hinge; wherein the display screen and the first connecting unit are capable of rotating by utilizing the first hinge, the base and the first connecting unit are capable of rotating by utilizing the second hinge, and the base and the second connecting unit are capable of rotating by utilizing the third hinge.

The claimed invention display device has a shape-changeable supporter so that the display device can utilize the space efficiently and allows the user to compact it easily. Moreover, the novel supporter also allows the display device to be hung upside down. Therefore, the claimed invention provides another choice for a better space utilization and placing method of the screen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a typical LCD display according to the prior art.

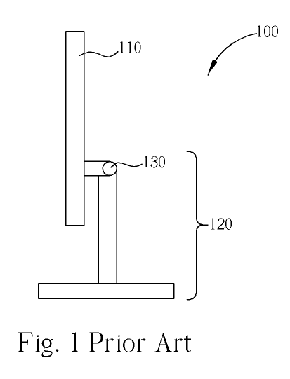

FIG. 2 is a diagram of an LCD display according to the present invention.

FIG. 3 is a diagram of the LCD display shown in FIG. 2 when the supporter is in a first shape according to the present invention.

FIG. 4 is a diagram of the LCD display shown in FIG. 2 when the supporter is in a second shape according to the present invention.

FIG. 5 is a diagram of the LCD display shown in FIG. 2 when the supporter is in a third shape according to the present invention.

### DETAILED DESCRIPTION

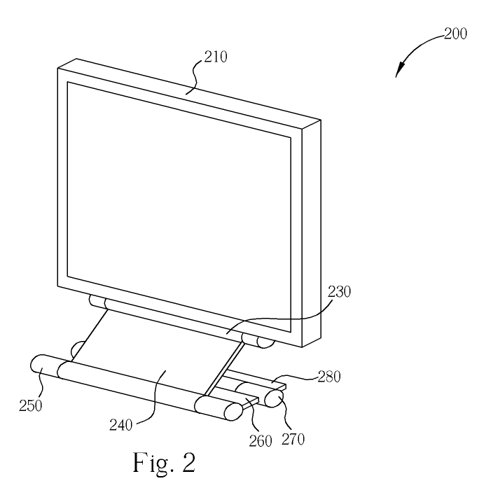

Please refer to FIG. 2, which is a diagram of an LCD display 200 according to the present invention. As shown in FIG. 2, the LCD display 200 comprises an LCD screen 210 and a supporter 220 for supporting the LCD screen 210. Please note that the present invention supporter 220 comprises three hinges 230, 250, and 270, two connecting pieces 240 and 280, and a base 260. In addition, the connection relationships among the devices of the supporter 220 are illustrated as follows. The hinge 230 is utilized to connect the connecting piece 240 and the LCD screen 210. The hinge 250 is utilized to connect the connecting piece 240 and the base 260. The hinge 270 is utilized to connect the base 260 and the connecting piece 280.

Due to the configuration of the hinges 230, 250, and 270; the connecting pieces 240 and 280; and the base 260; these pieces can utilize the hinges 230, 250, and 270 to adjust the various angles among themselves. In other words, the present invention supporter 220 can change its shape through utilizing the hinges 230, 250, and 270. Therefore, the present invention supporter 220 not only can adjust the view angle as well as the prior art supporter 120, but can also adjust the shape (e.g., such as the height of the LCD screen 210) such that the LCD display 200 can be utilized more flexibly than the prior art supporter 120.

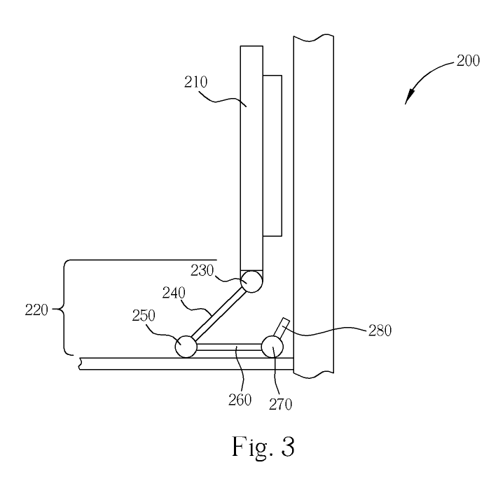

Please refer to FIG. 3, which is a diagram of the LCD display 200 shown in FIG. 2 when the supporter 220 is in a first shape according to the present invention. As shown in FIG. 3, when the LCD display 200 needs to be placed near the wall (or the desk), the connecting piece 280 and the base 260 can form a folded shape through utilization of the hinge 270. Therefore, the LCD display device 200 does not waste the space due to the connecting piece 280. Moreover, the hinge 250 can be placed on a plane whereby the hinge 270 lies on the wall. That is, the wall can provide the supporting force to the LCD display 200. In this configuration, the supporter 220 is located between the plane and the wall at an angle. In this configuration, the entire space of the LCD display 200 can be saved in order to utilize the placing space more efficiently.

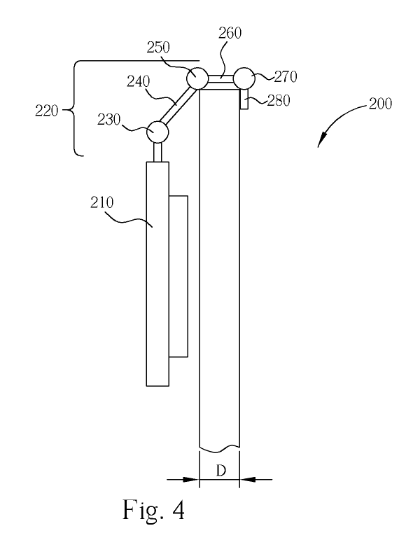

Please refer to FIG. 4, which is a diagram of the LCD display 200 shown in FIG. 2 when the supporter 220 is in a second shape according to the present invention. As shown in FIG. 4, the LCD display 200 can be hung upside down. When the LCD display 200 is hung upside down, the connecting piece 280 and the base 260 functions as a hook to stabilize the LCD screen 210. Surely, when the LCD display 200 is hung upside down, in order not to show the rotated picture, the LCD screen 210 must have the ability of inverting to output the picture. Those skilled in the art can know the technique of outputting the rotated picture and the further illustration is thus omitted here. In addition, because the structure of the present invention supporter 220 can be changed through different angles of the hinges 230, 250, and 270, in FIG. 4, for different width D, the supporter 220 can have a corresponding structure to allow the LCD screen 210 to be placed stably. In contrast to the above-mentioned prior art, the present invention supporter 220 not only allows the function of hanging the LCD screen upside down, but also has a corresponding solution for the width D of the wall. In other words, the present invention supporter 220 is able to change its shape to become a corresponding structure in order to ensure that the LCD screen 210 can be placed more stably as well as increases the flexibility of options for placement of the LCD display 200.

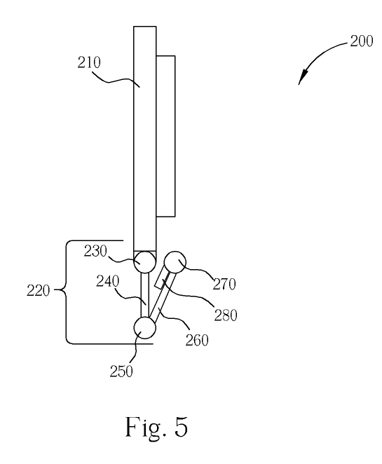

Please refer to FIG. 5, which is a diagram of the LCD display 200 shown in FIG. 2 when the supporter 220 is in a third shape according to the present invention. As shown in FIG. 5, when the LCD display 200 is compacted, each device of the supporter 220 can be folded up such that the packaging space can be minimized. As shown in FIG. 5, the entire LCD display 200 is almost folded up as a flat plate. Therefore, even when the LCD display 200 needs to be moved, although the LCD screen 210 is still connected to the supporter 220, the present invention LCD display 200 can be still be compacted in a smaller box. That is, the present invention LCD display 200 can be easily compacted and moved because of the shape-changeable supporter 220.

Please note that in the above disclosure, we assume that the hinges 230, 250, and 270 posses sufficient frictions. Therefore, the angles would not be changed easily to form unnecessary deformation. However, in order to prevent from the necessary deformation, lockers can be added to the hinges 230, 250, and 270 in order to maintain the angles. For example, once the angle between connecting piece 240 and base 260 is adjusted to an appropriate angle, the locker can be utilized to lock the angle of the hinge 250. Because the function and the manufacturing method of the locker are well known by those skilled in the art, they are omitted here.

Please note that the hinge 230 of the LCD display 200 shown in FIG. 2 is placed on the outer frame of the LCD screen 210. However, the present invention does not limit where the hinge 230 should be placed. That is, the present invention hinge 230 can be placed in the back of the LCD screen 210. This change also obeys the spirit of the present invention.

In contrast to the prior art, the present invention display device has a shape-changeable supporter so that the display device can utilize the space well and allows the user to compact it easily. Moreover, the novel supporter also allows the display device to be hung upside down. Therefore, the present invention provides another choice of a better space utilization and placing method of the screen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a display screen; and
a supporter comprising:
a first hinge connected to the display device;
a first connecting unit connected to the first hinge;
a second hinge connected to the first connecting unit;
a base connected to the second hinge;
a third hinge connected to the base; and
a second connecting unit connected to the third hinge;
wherein the display screen and the first connecting unit are capable of rotating by utilizing the first hinge, the base and the first connecting unit are capable of rotating by utilizing the second hinge, and the base and the second connecting unit are capable of rotating by utilizing the third hinge.

2. The display device of claim 1, wherein the first hinge further comprises a locker for fixing an angle between the display screen and the first connecting unit.

3. The display device of claim 1, wherein the second hinge further comprises a locker for fixing an angle between the base and the first connecting unit.

4. The display device of claim 1, wherein the third hinge further comprises a locker for fixing an angle between the base and the second connecting unit.

5. The display device of claim 1, wherein the display screen is a liquid crystal display (LCD) screen.

6. The display device of claim 1, wherein the first hinge is connected to an outer frame of the display screen.

7. The display device of claim 1, wherein the first hinge is connected to a back of the display screen.
